(19) United States
(12) Patent Application Publication
(10) Pub. No.: US 2004/0090652 A1
(43) Pub. Date: May 13, 2004

(54) Printer, and control method thereof, having extended communication interface functions

(76) Inventor: Tae-jung Yoon, Seoul (KR)

Correspondence Address: STAAS & HALSEY LLP, SUITE 700, 1201 NEW YORK AVENUE, N.W., WASHINGTON, DC, 20005, US

(21) Appl. No.: 10/688,911

(22) Filed: Oct. 21, 2003

(30) Foreign Application Priority Data
Oct. 22, 2002 (KR) 2002 64572

(51) Int. Cl. G06F 13/00; G06F 15/00; G06F 3/12

(52) U.S. Cl. 358/1.16; 358/1.15; 719/321

(57) ABSTRACT

A printer receives a data card and an interface card as function extension cards. The printer has at least one card slot receiving a data card storing image data and/or a specific execution file and an interface card for data communication with an external apparatus. A detection unit detects whether a memory card installed in the card slot is the data card or the interface card, and a control unit determines whether to execute the interface card, if the interface card is installed in the card slot according to the detection unit, to communicate with the external apparatus. Accordingly, the function extension cards allow mutual data communication between the printer and various external apparatuses having various interfaces, and also new functions not supported by the printer can be added.

### CROSS-REFERENCE TO RELATED APPLICATIONS

This application claims the benefit of Korean Application No. 2002-64572, filed Oct. 22, 2002, in the Korean Intellectual Property Office, the disclosure of which is incorporated herein by reference.

### BACKGROUND OF THE INVENTION

1. Field of the Invention

The present invention relates to a printer and a control method thereof, and more particularly, to a printer with an extended function through the use of a memory card and an interface card, and a control method thereof.

2. Description of the Related Art

A printer is an image printing apparatus that is most widely used for outputting information processed at an external apparatus, such as a computer or an image scanner, to another visible form, such as paper, that can be perceived by human eyes.

FIG. 1 is a block diagram of a conventional printer. Referring to FIG. 1, the conventional printer has an interface 10, a storage unit 20, a memory card slot 30, a control unit 40, and a printing unit 50. The interface 10 connects with an external apparatus, such as a computer (not shown) or a PDA, through a communication interface (not shown), and supports data communication between the external apparatus and the control unit 40. The storage unit 20 has a ROM 22 to store various controlling programs required to realize the functions of the printer, and a RAM 24 to temporally store data generated while performing the operations of the printer and printing data transmitted from the external apparatus through the interface 10. The memory card slot 30 interfaces the communication between a memory card (not shown) as an external storage device and the control unit 40. The memory card is a supplementary memory device, such as a compact flash or a smart media.

Upon receipt of power supply, the control unit 40 controls the entire operation of the printer in accordance with a controlling program stored in the storage unit 20. The control unit 40 detects whether the memory card (not shown) is installed in the memory card slot 30, and if determined that the memory card is installed, the control unit reads image (print) data stored in the memory card and controls the printing unit 50 to operate printing operations. The control unit 40 also causes the data generated during the printing operations to be transmitted to, and stored in the memory card. In addition, the control unit 40 converts image data transmitted from the external apparatus through the interface 10 into image data readable by the printing unit 50, and controls the printing unit 50 to print the image data. Therefore, the printing unit 50 performs printing of printing data in accordance with the controlling of the control unit 40.

However, with the printer having the above structure, it is hard to add a new function as requested by a user or as necessary, because the storage unit 20 has limited storage capacity. Accordingly, addition of protocols, functions and applications is always limited without an extension of the memory. In particular, with the limited capacity of ROM 22, addition of functions is also limited within a certain extent.

In the meantime, connection with an external apparatus is only done through the interface 10 installed as hardware, thus there is a problem that the communication with an external apparatus having a new interface that is not installed in the printer cannot be performed.

### SUMMARY OF THE INVENTION

The present invention provides a printer, and a control method thereof, using an interface card to communicate with external apparatuses having various interfaces, and also using a data card having a plug-in program to improve the functions of the printer.

Additional aspects and advantages of the invention will be set forth in part in the description which follows and, in part, will be obvious from the description, or may be learned by practice of the invention.

The present invention may be achieved by a printer comprising at least one card slot receiving a memory card having an image (print) data and/or a specific execution file stored therein and receiving an interface card for data communication with an external apparatus, a detection unit detecting whether a card installed in a card slot is the memory card or the interface card, and a control unit executing the interface card, if determined that the interface card is installed in the card slot according to the detection, and communicating with the external apparatus according to the interface card executing.

According to an aspect of the invention, a storage unit stores more than one device driver corresponding to a plurality of interface cards. The control unit determines whether a device driver corresponding to the installed interface card is stored in the storage unit, and accordingly determines whether to execute the interface card, and if determined that there is no device driver corresponding to the installed interface card in the storage unit, the control unit outputs a message that the interface card cannot be executed.

According to an aspect of the invention, the printer further comprises another card slot receiving a memory card storing the device driver corresponding to the installed interface card in a specific execution file form, if there is no device driver corresponding to the installed interface card stored in the storage unit.

According to an aspect of the invention, the control unit generates a message to request that the memory card, which stores the device driver corresponding to the installed interface card, be installed in the other card slot.

According to an aspect of the invention, if determined by the detection unit that the memory card is installed in the other card slot, the control unit determines whether the specific execution file exists from among files stored in the memory card, and executes the specific execution file, if determined that the memory card stores the specific execution file.

The present invention may also be achieved by a method of controlling a printer, comprising receiving in at least one card slot a memory card and an interface card for data communication with an external apparatus, storing at least one device driver corresponding to a plurality of interface cards, detecting a type of a card installed in a card slot, and upon determining that the installed card is an interface card according to the detecting, executing the interface card, and controlling data communication with the external apparatus according to the interface card executing.

According to an aspect of the invention, the interface card executing comprises determining whether there is a stored device driver corresponding to the installed interface card to execute the installed interface card.

According to an aspect of the invention, the determining whether the device driver corresponding to the installed interface card is stored in the storage unit, comprises generating a message requesting installation of a memory card storing the device driver corresponding to the installed interface card, if there is no stored device driver.

According to an aspect of the invention, the interface card executing comprises executing the device driver stored in the requested installed memory card to execute the interface card.

According to an aspect of the invention, the determining whether the device driver corresponding to the installed interface card is stored in the storage unit comprises determining whether the device driver exists in a specific execution file form from among files stored in the installed memory card, and if determined that the specific execution file exists, executing the specific execution file to execute the interface card.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a functional block diagram of a conventional printer;

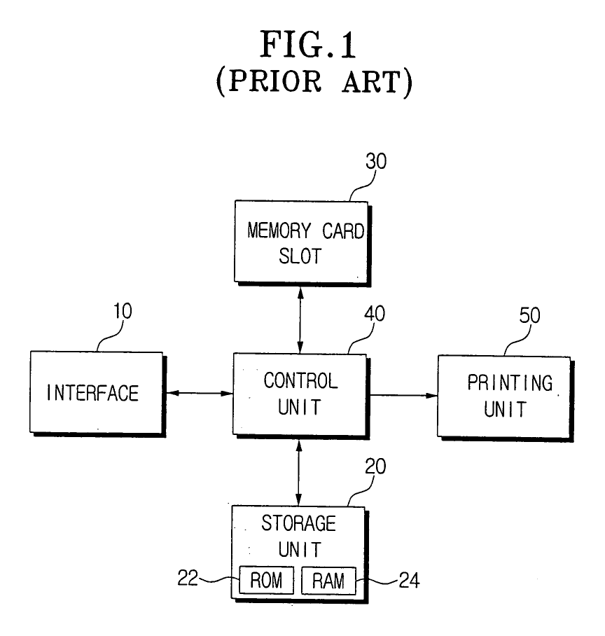

FIG. 2 is a functional block diagram of a printer, according to an embodiment of the present invention; and

FIG. 3 is a flow chart of controlling the printer shown in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

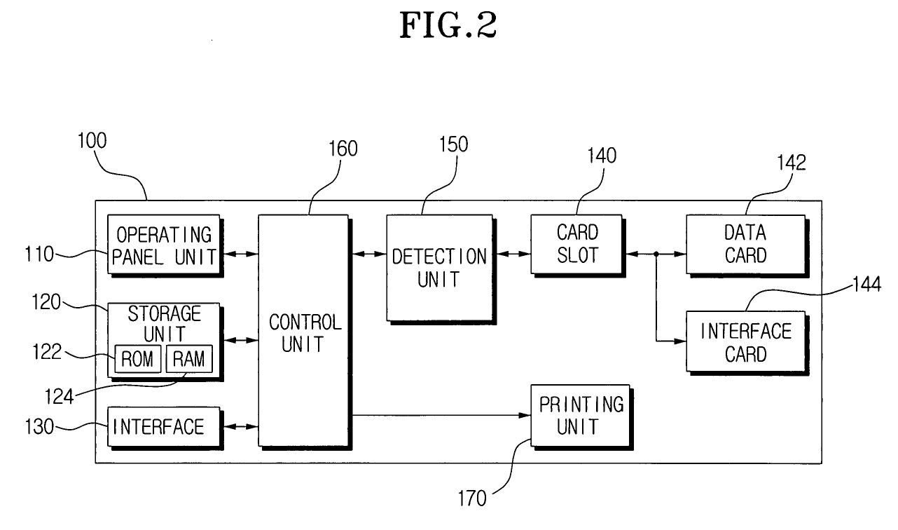

FIG. 2 is a functional block diagram of a printer, according to an embodiment of the present invention. Referring to FIG. 2, a printer 100 of the present invention has an operating panel unit 110, a storage unit 120, an interface 130, a card slot 140, a detection unit 150, a control unit 160 and a printing unit 170. The operating panel unit 110 comprises an input unit (not shown) having a plurality of keys for setting up various functions supported by the printer 100 and a display unit (not shown) displaying the operation status of the printer 100 according to the control of the control unit 160.

Typically, the storage unit 120 has a ROM 122 and a RAM 124. Typically, the ROM 122 is a non-volatile memory and stores various programs realizing (performing) the functions of the printer 100 (i.e., the ROM 122 stores programs controlling the printer functions). Typically, the RAM 124 is a volatile memory, and, typically, the RAM 124 stores printing data transmitted from an external apparatus through the interface 130 and data generated while performing the operations of the printer 100. Moreover, the RAM 124 stores more than one device driver corresponding to a plurality of interface cards.

The interface 130 supports mutual data communication to connect with an external apparatus (not shown). Typically, the IEEE 1284 and the USB (Universal Serial Bus) modules are used for the interface 130, and a computer (not shown), a scanner (not shown) or a PDA can be applied as the external apparatus connected with the printer 100 via the interface 130.

The card slot 140 receives a memory card, which, typically, is a compact memory card. More particularly, the card slot 140 receives a data card 142 storing image data and/or a specific execution file and an interface card 144 providing data communication with an external apparatus. The card slot 140 generates an external apparatus insert signal to the detection unit 150 when the memory card 142 or the interface card 144 is installed therein. The compact memory card can be any compact memory card, such as a compact flash, a smart media, a memory stick or an SD memory card, that can be installed in and removed from the card slot 140.

The data card 142 stores an image (print) data and/or a specific execution file supporting various functions of the printer 100. The specific execution file stored on the data card 142 may be, for example, a program stored in a plug-in form. A plug-in program is a program that can be used inside of the ROM 122 or the RAM 124, although the plug-in program is not a function stored in ROM 122 or RAM 124, because general plug-in programs do not have an independent interface and are used only by being connected with a main program. A plug-in of PHOTOSHOP is one example of a plug-in program.

The interface card 144 supports mutual data communication between the printer 100 and external apparatuses having various interfaces connected with the printer 100 through the interface 130. As for the interface card 144, for example, a modem, a LAN, a wireless LAN, a Bluetooth and a GSP module can be used.

The detection unit 150 detects whether a memory card installed in the card slot 140 is the data card 142 or the interface card 144, and transmits the detection result to the control unit 160. The detection unit 150 can detect a memory card type by using the information of the memory card installed in the card slot 140.

Typically, the control unit 160 controls the entire operation of the printer 100 in accordance with a controlling program stored in the storage unit 120 when power is supplied to the printer 100. For example, when a memory card is not installed in the card slot 140, the control unit 160 performs the general operations of the printer 100 according to the stored controlling program and data, such as image data, received via the interface 130. However, if the memory card is installed in the card slot 140, the control unit 160 controls the printer 100 operations according to a detection result signal of the detection unit 150.

If the detection unit 150 detects that an interface card 144 is installed in the card slot 140, the control unit 160 detects whether the interface card 144 is executable and performs the communication with the external apparatus. The fact that the interface card 144 is installed in the card slot 140 does not mean that the interface card 144 can be operated. Typically, to operate the interface card 144, a device driver corresponding to the installed interface card 144 is required. Therefore, the control unit 160 confirms whether a device driver for the installed interface card 144 is stored in the storage unit 120. When a device driver corresponding to the installed interface card 144 is stored in the storage unit 120, the stored device driver can be used to operate/control the interface card 144.

However, if there is no device driver corresponding to the installed interface card 144 stored in the storage unit 120, the control unit 160 outputs a message, via the operating panel unit 110, that the interface card 144 cannot be operated. According to an aspect of the invention, another card slot (not shown) may be provide in the printer 100 to receive a data card storing a device driver corresponding to the installed interface card 144 in plug-in program form. However, the present invention is not limited to a two card slot configuration, and a one card slot may be used to read/download the device driver from the data card 142 before executing the interface card 144. Therefore, the control unit 160 operates the interface card 144 by executing the device driver, which is either previously stored in the storage unit 120 or stored in a plug-in program form in an installed data card 142.

If the detection unit 150 detects that a data card 142 is installed in the card slot 140 (i.e., the detection unit 150 detects that an interface card 144 is not installed in the card slot 140), the control unit 160 confirms whether a specific execution file, typically a plug-in program, exists by checking a file list stored in the data card 142. Typically, the data card 142 has a DOS File System storing files in level structure. Therefore, if confirmed that there is a plug-in program by checking the list of files stored in the data card 142, the control unit 160 provides a menu for selecting the execution of the plug-in program through the operating panel unit 110, such as a display unit. At this time, when a user selects a plug-in program, the control unit 160 controls to perform a specific function by operating the selected plug-in program. If confirmed that there is no plug-in program stored in the data card 142, the control unit 160 determines that the data card 142 is a general external storage device, and controls operations to perform printing after reading image (print) data stored in the data card 142. Also, the control unit 160 can control operations, such that any data generated during the operation of the printer 100 can be stored into the data card 142. The printing unit 170 performs printing operations with respect to image (print) data according to the control unit 160.

Although in the above-described embodiment, the detection unit 150 detecting the type of the memory card installed in the card slot 140 and the control unit 160 controlling the entire operation of the printer 100 are provided as separated parts, the present invention is not limited to such a configuration and the control unit 160 can be configured (e.g., programmed) to perform the function of the detection unit 150.

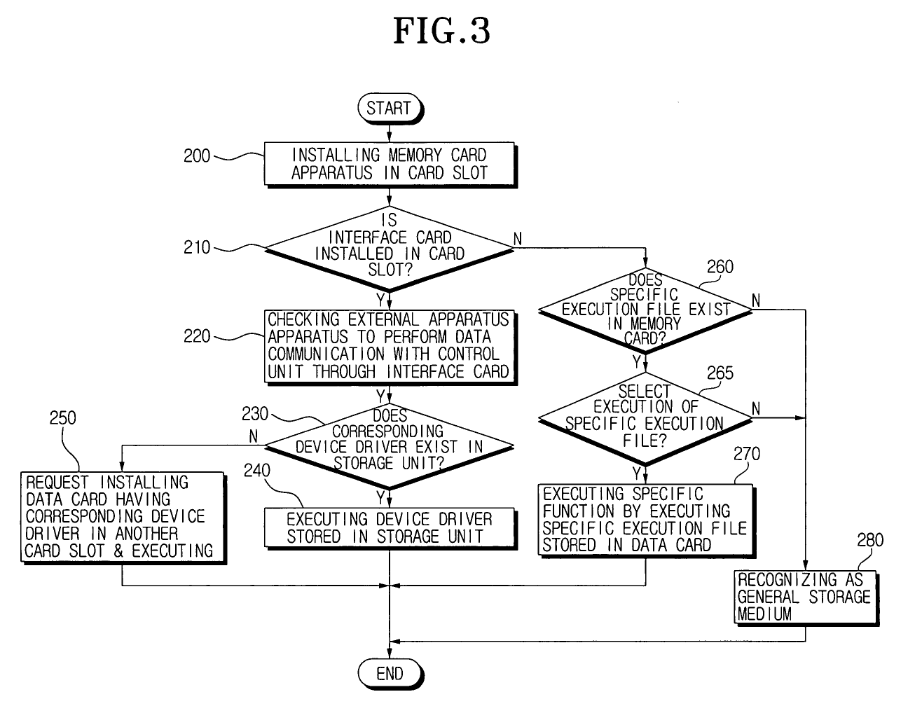

FIG. 3 is a flow chart of controlling the printer shown in FIG. 2. Referring to FIG. 3, at operation 200, a memory card is installed in the card slot 140. At operation 210, the detection unit 150 detects whether the memory card installed in the card slot 140 is the data card 142 or the interface card 144.

If detected at operation 210 that the interface card 144 is installed in the card slot 140, at operation 220, the control unit 160 checks for an external apparatus to perform data communication with the printer 100 through the interface card 144. At operation 230, the control unit 160 determines whether a device driver corresponding to the interface card 144 is stored in the storage unit 120 to determine whether to execute the interface card 144 (i.e., whether the interface card 144 is executable).

If determined at operation 230 that the storage unit 120 has a device driver corresponding to the interface card 144 installed in the card slot 140, at operation 240, the control unit 160 operates the interface card 144 by executing the device driver stored in the storage unit 120. If determined at operation 230 that that a device driver corresponding to the interface card 144 is not stored in the storage unit 120, at operation 250, the control unit 160 requests installation of a data card 142 storing a corresponding device driver, typically in the plug-in program form. After operation 250, the processing by the control unit 160 returns to operation 200, which detects installation of a memory card in the card slot 140. Accordingly, after operation 250, if the data card 142 is installed in the same card slot or another card slot, at operation 260 the control unit 160 detects the data card 142 and operates (e.g., download, read, etc.) the device driver stored in the installed data card 142.

Therefore, if after operation 250 a memory card is installed in the card slot, operation 210 detects whether the installed memory card is an interface card 144. If operation 210 detects that the installed memory card is not an interface card 144, operation 260 determines if the installed memory card is the data card 142. In particular, at operation 260, the control unit 160 checks whether a device driver corresponding to the installed interface card 144 as a plug-in program is stored in the installed memory card, thereby the installed memory card is deemed as a data card 142. If operation 260 determines that a plug-in program is stored in the installed memory card as the data card 142, at operation 265, the control unit 160 outputs a menu to select whether to execute the plug-in program stored in the data card 142.

If, at operation 265, a request to execute the plug-in program stored in the data card 142 is received from the user, at operation 270, the control unit 160 performs a specific function by executing the plug-in program stored in the data card 142. If operation 260 determines that a plug-in program is not stored in the installed memory card, at operation 280, the control unit 160 perceives the installed memory card as a general external storage device. Moreover, the control unit 160 perceives the installed memory card as a general storage medium if, at operation 265, the user does not select execution of the plug-in program even when the plug-in program exists in the installed memory card as the data card 142.

According to the printer and the control method thereof of the present invention, when a new function, such as an interface/communication protocol for a new external apparatus/software application, new or upgrade printer functions, etc., not supported by the printer is added, it is easy to accordingly extend the function of the printer by using memory cards as printer function extension cards, which provide interface, including device driver thereof, software. Therefore, the function extension card of the invention reduces the cost of extending the printer functions, because the memory cards storing the interface programs and/or the plug-in programs may not require expanding the system memory. Moreover, because an interface card is installed in the printer card slot, the utilization of the printer card slot is upgraded by being extended from a conventional printer card slot solely used for receiving a memory card as a general external storage medium to a printer function extension card slot. For example, if a function extension card is used as an interface card for communicating data with external apparatuses, mutual data communication with other external apparatuses having various interfaces can be achieved. The processes of the present invention, which are typically embodied in the control unit 160 and the detection unit 150, can be implemented in software and/or computing hardware.

More particularly, the present invention provides a printer, comprising a card slot receiving a memory card and a function extension type memory card; and a programmed computer processor detecting whether an installed card is the function extension type card, and executing the function extension type card to communicate with an external apparatus having a compatible communication interface with a communication interface stored in the extension type card. Further, the programmed computer processor executes the function extension type card to execute printer functions, such as newly added or upgraded printer functions. Accordingly, the addition of data communication protocols, functions and applications is easy without expanding the printer memory.

Although a few embodiments of the present invention have been described, it will be understood by those skilled in the art that the present invention should not be limited to the described embodiments, but various exchanges and modifications can be made within the spirit and the scope of the present invention, the scope of which is defined in the claims and their equivalents.

What is claimed is:

1. A printer, comprising:
at least one card slot receiving a data card having an image data and/or a specific execution file stored therein and an interface card for data communication with an external apparatus;
a detection unit detecting whether a memory card installed in the card slot is the data card or the interface card; and
a control unit determining whether to execute the interface card, if the interface card is installed in the card slot according to the detection unit, and communicating with the external apparatus according to the executing interface card.

2. The printer of claim 1, further comprising:
a storage unit storing more than one device driver corresponding to an installed interface card,
wherein if the interface card is installed in the card slot according to the detecting unit, the control unit determines whether a device driver corresponding to the installed interface card is stored in the storage unit to execute the interface card, and if the control unit determines that a device driver corresponding to the installed interface card is not stored in the storage unit, the control unit outputs a message that the interface card cannot be executed.

3. The printer of claim 2, further comprising:
another card slot receiving the data card storing the device driver corresponding to the installed interface card, if the device driver corresponding to the installed interface card is not stored in the storage unit.

4. The printer of claim 2, wherein if the control unit determines that the device driver corresponding to the installed interface card is not stored in the storage unit, the control unit generates a message requesting installation in the card slot of the data card storing the device driver corresponding to the installed interface card.

5. The printer of claim 1, wherein if the data card is installed in the card slot according to the detection unit, the control unit determines whether a specific execution file exists from among files stored in the data card, and executes a specific function by executing the specific execution file, if the specific execution file is stored in the memory card.

6. A method of controlling a printer having at least one card slot receiving a data card and an interface card for data communication with an external apparatus, a storage unit storing at least one device driver corresponding to the interface card, a detection unit detecting a memory card type installed in the card slot, and a control unit, the control method comprising:
detecting whether a memory card installed in the card slot is the data card or the interface card; and
upon determining that the interface card is installed in the card slot, executing the interface card and controlling data communication with the external apparatus according to the executing interface card.

7. The method of claim 6, wherein the interface card executing comprises determining whether the installed interface card is executable by determining whether there is a device driver corresponding to the interface card stored in the storage unit.

8. The method of claim 7, wherein the determining whether the device driver corresponding to the installed interface card is stored in the storage unit comprises generating a message requesting installation of the data card storing the device driver corresponding to the installed interface card, if the devise driver is not stored in the storage unit.

9. The method of claim 8, wherein the interface card executing comprises executing the device driver stored in the requested installed data card to execute the interface card.

10. The method of claim 7, wherein the determining whether the device driver corresponding to the installed interface card is stored in the storage unit further comprises determining whether a specific execution file exists from among files stored in the data card, and if determined that the specific execution file exists in the data card, executing the specific execution file to execute the interface card.

11. A printer, comprising:
a card slot receiving a memory card; and
a programmed computer processor detecting whether the received memory card is a function extension type card, and executing the function extension type card to communicate with an external apparatus having a compatible communication interface with a communication interface stored in the extension type card.

12. The printer of claim 11, wherein the programmed computer processor further executes the function extension type card to execute new printer functions.

13. The printer of claim 11, wherein the received function extension type card stores a plug-in program as a device driver; and
the programmed computer processor executes the plug-in program to execute the function extension type card.
